(19) United States
(12) Patent Application Publication
(10) Pub. No.: US 2022/0100953 A1
(43) Pub. Date: Mar. 31, 2022

(54) SYSTEM AND METHOD FOR AUTOPRODUCING A FORM

(71) Applicant: Verint Americas Inc., Alpharetta, GA (US)

(72) Inventor: Neil Eades, Glasgow (GB)

(73) Assignee: Verint Americas Inc., Alpharetta, GA (US)

(21) Appl. No.: 17/038,865

(22) Filed: Sep. 30, 2020

(51) Int. Cl. G06F 40/174; G06F 40/106; G06F 40/186; G06Q 10/10

(52) U.S. Cl. CPC G06F 40/174; G06Q 10/10; G06F 40/186; G06F 40/106

(57) ABSTRACT

The present invention is a method and system for automatically producing a form. Upon receiving at least one type of data input, the system analyzes the data input and produces a form based on the results of the analysis of the data input. This process may be used to either generate or update a form, and may be repeated to update an existing form.

### BACKGROUND

The present disclosure is directed to a method for computer analysis, specifically a method for analyzing data and creating a form.

In modern business environments, forms are designed to ensure that a user obtains all data necessary for a task. Such tasks may include, but are not limited to, taking an order, registering a complaint, setting up or changing a customer account, and so on. By way of non-limiting example, an order form may include an item number, number of items requested, client payment data, and shipping data. However, new security requirements and new data needed for a task may not have a place in existing forms.

Unfortunately, supervisory or planning staff may not have the time or understanding to design and update forms. If, for example, a member of planning staff is unaware of new payment security requirements, they are unable to include these requirements in a new form. If a member of supervisory staff is unaware of new data types being required for each transaction, they cannot update the form so that employees under them acquire such data. Furthermore, companies with large numbers of divisions may be unable to timely and adequately establish and update common forms across every division. Rather than relying on staff for the generation and update of forms, use of an automated system could determine what a form needs to meet the needs of the organization.

There is an unmet need in the art for a system and method capable of automatically assessing what data fields are necessary for a form. There is a further unmet need in the art for a system and method capable of integrating these assessments to create a form or modify and existing form with the results of such an assessment.

### SUMMARY

An exemplary embodiment of the present application is a method for automatically producing a form using a development system. The method provides the development system. The development system includes a development analytics engine which is operably connected to and receives input from at least one of a base data source, a feedback data source, and an external system. The method then receives at least one type of data input from the at least one base data source, feedback data source, or external system, analyzes the data input using the development analytics engine, and produces a form based on the results of the analysis of the data input.

Another exemplary embodiment of the present application is a system for automatically producing a form. The system includes a processor and a non-transitory computer readable medium programmed with computer readable code that upon execution by the processor causes the processor to execute the above-mentioned method for automatically producing a form.

Another exemplary embodiment of the present application is a non-transitory computer readable medium programmed with computer readable code that upon execution by a processor causes the processor to execute the above-mentioned method for automatically producing a form.

The objects and advantages will appear more fully from the following detailed description made in conjunction with the accompanying drawings.

### BRIEF DESCRIPTION OF THE DRAWING(S)

FIG. 1a illustrates an exemplary embodiment of a development system for creating a form. FIG. 1b illustrates an exemplary embodiment of the form.

FIGS. 2a and 2b illustrate a flowchart of an exemplary embodiment of a method for creating the form.

FIG. 3 illustrates an exemplary embodiment of a computing system for performing the method for creating the form.

### DETAILED DESCRIPTION

In the present description, certain terms have been used for brevity, clearness and understanding. No unnecessary limitations are to be applied therefrom beyond the requirement of the prior art because such terms are used for descriptive purposes only and are intended to be broadly construed. The different systems and methods described herein may be used alone or in combination with other systems and methods. Various equivalents, alternatives and modifications are possible within the scope of the appended claims. Each limitation in the appended claims is intended to invoke interpretation under 35 U.S.C. § 112, sixth paragraph, only if the terms “means for” or “step for” are explicitly recited in the respective limitation.

In business environments, forms are designed to ensure that customer and in-house transactions are supported by sufficient data. Rather than have such forms created by staff, the development system instead determines what a form needs to achieve for each specific transaction. These goals are based on the overall requirements of the company, legal requirements, and the specific requirements of the transaction.

The development system receives and performs analysis of base data. Such base data may be received as input from an automated system (including the development system itself or an external system), manually input, or a combination of the two. Base data may be weighted according to predetermined criteria. The base data types may include, in both the short and the long trend, any data which could be a requirement of a transaction or of use to the organization.

This analysis leads to generation of the optimal form for each task or transaction. Adherence to the form may be monitored, with compliance reported to a third party or used to adjust the form. Feedback metrics may include use of a particular data field, a user's evaluation of various ease-of-use characteristics of the form, or any other metric. The form may also be automatically modified when any of the base data changes, e.g. changes to payment security requirements or different product tracking.

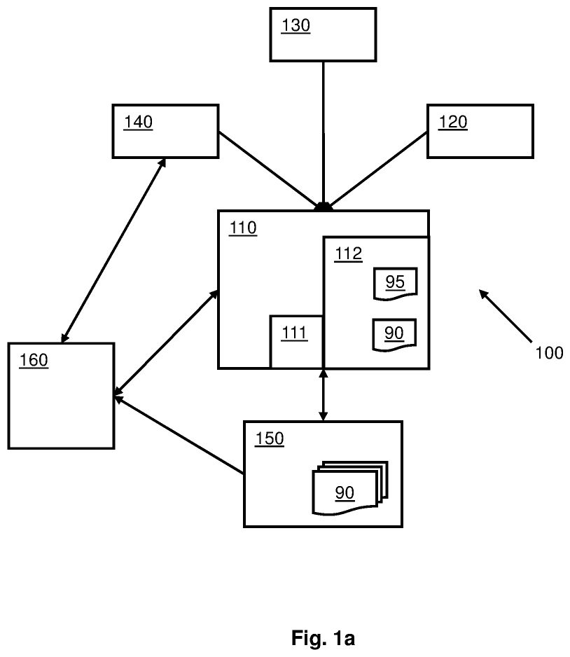

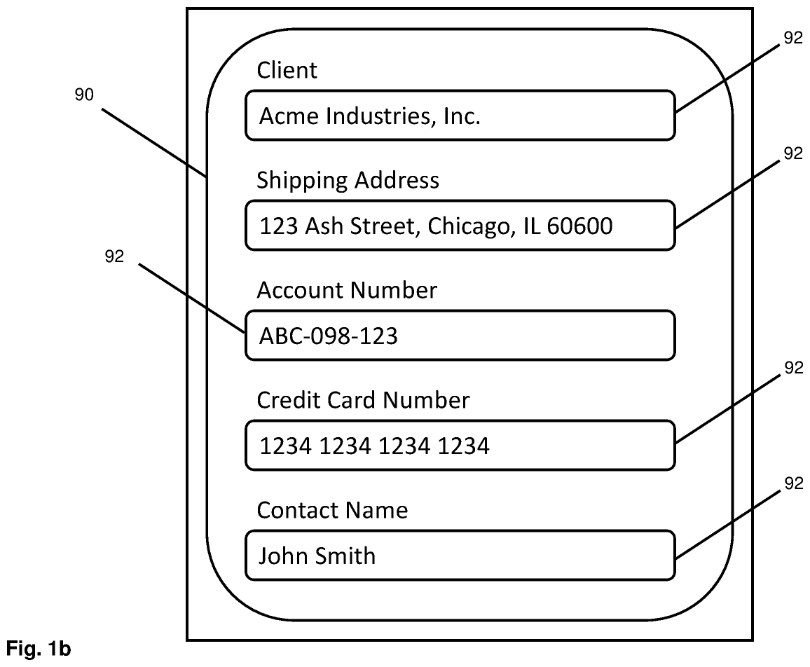

FIG. 1a depicts an exemplary embodiment of a development system 100 for creating a form 90 with at least one data field 92, shown in FIG. 1b. Development system 100 includes a development analytics engine (DAE) 110 which receives input from at least one base data source 120, feedback data source 130, and/or external system 140 to produce at least one form 90. Production of the form 90 may entail generating a new form 90 and/or updating an existing form 90. An optional form database 150 allows storage of forms 90, while a desktop 160 allows additional input to development analytics engine 110 as well as display of forms 90.

The development analytics engine 110 is configured to receive and analyze data within development system 100. Analysis may be a real-time analysis of streaming data or batch analysis of data. The development analytics engine 110 includes at least one set of analytics rules 111 used to analyze data. The analytics rules 111 determine responses to information extracted from base data and/or feedback data, creating form 90. The analytics rules 111 may be static or may be dynamically updated by development analytics engine 110, external system 140, and/or an employee or third party utilizing desktop 160. Updates may be manual or automatic. Automatic updates to analytics rules 111 may be triggered by meeting certain criteria within analytics rules 111 of development analytics engine 110 or within external system 140, or may occur at predetermined intervals. The analytics rules 111 may be software programs or separate files executed by a software program.

In certain embodiments, the development analytics engine 110 generates at least one compliance metric 95 utilizing the results of the analysis and comparison with the form 90. The compliance metric 95 measures a user's usage of the form 90. For example, if a data field 92 noted as optional is used at a high level for a particular task, the development analytics engine 110 may make the field a requirement. If a data field 92 noted as optional is used at an extremely low level for a particular task, the development analytics engine 110 may remove the field. In certain embodiments, the development analytics engine 110 also includes development analytics memory 112. The development analytics memory 112 can store forms 90, data used for analysis, the results of that analysis, analytics rules 111, or any other information or data used by development system 100.

While the exemplary embodiment includes one development analytics engine 110, development system 100 may include more development analytics engines 110. In embodiments with multiple development analytics engines 110, DAEs 110 may be constantly connected, periodically connected, interconnected through at least one external system 140, form database 150, and/or desktop 160, or separate. In embodiments with a single development analytics engine 110, development analytics engine 110 is connected, directly or indirectly, to all external systems 140, form databases 150, and/or desktops 160.

The external systems 140 may be connected to development analytics engine 110, other external systems 140, form databases 150, and/or desktops 160. In certain embodiments, some external systems 140 connect development analytics engine 110 to certain other external systems 140 and/or form databases 150. The external systems 140 provide different data and functionalities to development system 100. By way of non-limiting example, external system 140 may be an email system, texting system, telephone system, internet access system, and/or another system for customer interaction. By way of another non-limiting example, external system 140 may be a customer service protocol database, work resource system, human resources system, internal work system, scheduling and/or calendaring system, and/or another system internal to a business.

A single external system 140 may perform multiple processes, a single process, and/or part of a larger process. In embodiments with multiple development analytics engines 110, each development analytics engine 110 may be connected to a unique set of external systems 140 or may share all or some specific external systems 140. External systems 140 can be updated by adding, updating, or removing specific external systems 140. The connections between development analytics engines 110, external systems 140, form databases 150, and desktops 160 may also be updated.

The external system 140 may also provide input from base data source 120 and feedback data source 130 to development analytics engine 110 for analysis, or may analyze such data and apply the results directly. By way of non-limiting example, external systems 140 may perform voice and text analytics, quality analytics, analytics relating to user feedback from feedback data source 130, and any other analysis related to use of form 90. The external systems 140 may provide the results of such analyses to development analytics engine 110 or to other external systems 140. By way of further non-limiting example, external systems 140 may also interact with the functions of desktop 160. Such interactions may allow another desktop 160 to observe and/or share another desktop 160, and utilize, update, or transmit or retrieve information to or from certain functions of the desktop 160.

The form databases 150 are connected to development analytics engine 110 and may be connected to other form databases 150 and/or external systems 140. The form databases 150 store forms 90 for use by development system 100 and system users. System users can include employees to whom forms 90 are directed for use, and HR and/or supervisory staff. By way of non-limiting example, form databases 150 may store standardized and/or pregenerated forms 90, various iterations of specific forms 90, forms 90 for a specific client or purpose, and/or any combination thereof. The forms 90 stored in form databases 150 may be categorized by client, date created and/or updated, business division, purpose, feedback rating, or any other possible classification schema. The form databases 150 can be updated by adding, changing, or removing forms 90. The connections between development analytics engine 110, external systems 140, and form databases 150 may also be updated.

The desktop 160 receives and displays forms 90 from form databases 150 and/or development analytics engines 110. Processes from external systems 140 may also interact with the processes of desktop 160. By way of non-limiting example, an external system 140 may receive forms 90 submitted from a website, analyze their content, and determine if the data fields 92 are adequate. Optionally, desktop 160 may also be used to provide input from base data source 120 or feedback data source 130, modify analytics rules 111, or submit a request to development analytics engine 110.

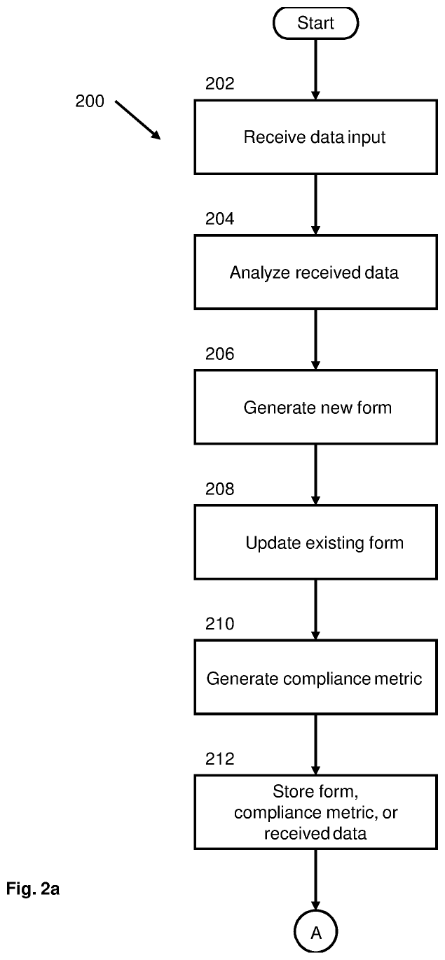

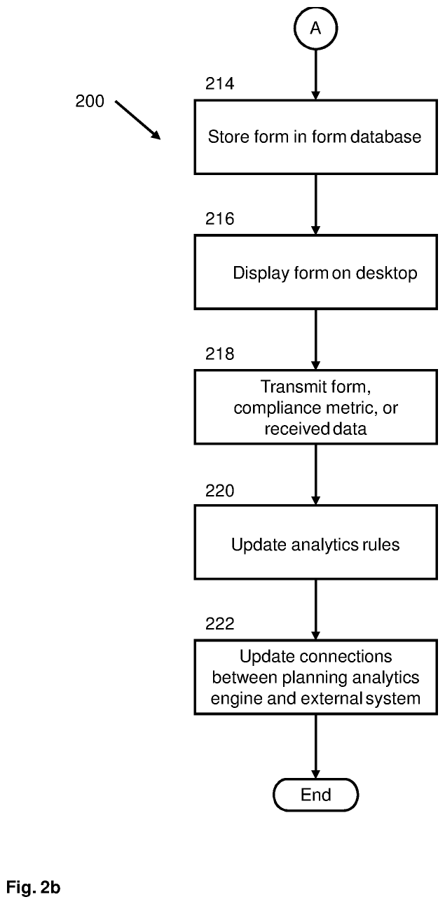

FIGS. 2a and 2b depict a flowchart of an exemplary embodiment of a method 200 for creating and modifying form 90. It should be understood that the arrangement of the steps of method 200 may be reordered and/or certain steps performed simultaneously as long as the fundamental function of method 200 remains unaltered.

In step 202, the development analytics engine 110 of the development system 100 receives data input from at least one base data source 120, feedback data source 130, and/or input from at least one external system 140.

In step 204, the development analytics engine 110 utilizes at least one set of analytics rules 111 to analyze received data. This analysis may be a real-time analysis of streaming data or batch analysis of data.

In optional step 206, the development analytics engine 110 generates at least one new form 90 utilizing the results of the analysis of step 204.

In optional step 208, the development analytics engine 110 updates at least one existing form 90 utilizing the results of the analysis of step 204.

In optional step 210, the development analytics engine 110 generates at least one compliance metric 95 utilizing the results of the analysis of step 204.

In optional step 212, development system 100 stores at least one of the form 90, the compliance metric 95, or received data in the development analytics memory 112.

In optional step 214, development system 100 stores at least one form 90 in the form database 150.

In optional step 216, development system 100 displays at least one form 90 on at least one desktop 160.

In optional step 218, the development system 100 transmits at least one of the form 90, the compliance metric 95, or received data to at least one external system 140 or at least one desktop 160.

In optional step 220, the development system 100 updates the analytics rules 111 of the development analytics engine 110.

In optional step 222, the development system 100 updates the connections between development analytics engine 110 and at least one external system 140. External systems 140 can be updated by adding, updating, or removing specific external systems 140.

It should be understood that method 200 may be divided into separate parts and practiced separately. By way of non-limiting example, steps 202, 204, and 208 may be repeated multiple times to update an existing form multiple times.

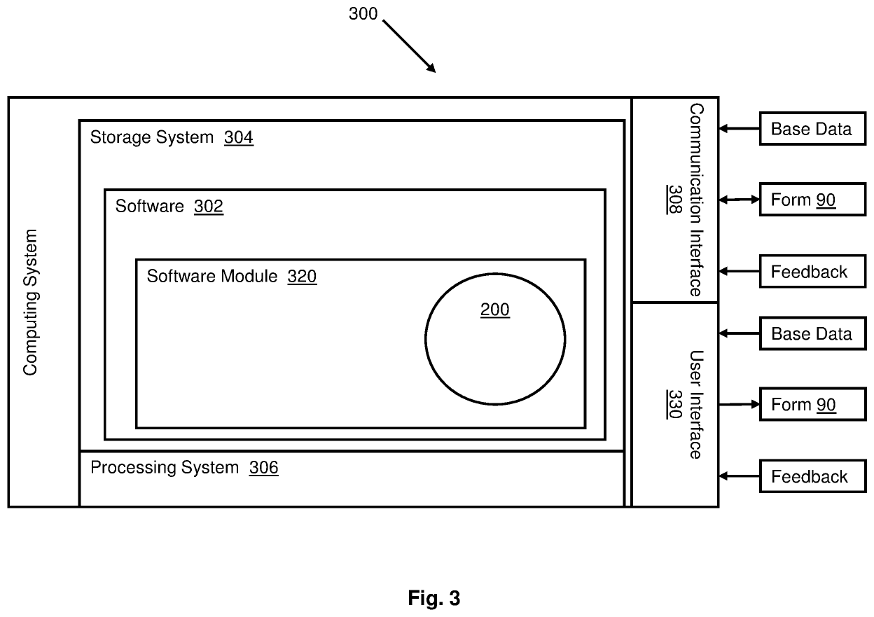

FIG. 3 depicts an exemplary embodiment of computing system 300 for performing the method 200 for creating form 90.

The system 300 is generally a computing system that includes a processing system 306, a storage system 304, software 302, a communication interface 308, and a user interface 310. The processing system 306 loads and executes software 302 from the storage system 304, including a software module 320. When executed by computing system 300, software module 320 directs the processing system 306 to operate as described in herein in further detail in accordance with the method 200.

The computing system 300 includes a software module 320 for generating form 90. Although computing system 300 as depicted in FIG. 3 includes one software module 320 in the present example, it should be understood that more modules could provide the same operation. Similarly, while the description as provided herein refers to a computing system 300 and a processing system 306, it is to be recognized that implementations of such systems can be performed using one or more processors, which may be communicatively connected, and such implementations are considered to be within the scope of the description. It is also contemplated that these components of computing system 300 may be operating in a number of physical locations.

The processing system 306 can comprise a microprocessor and other circuitry that retrieves and executes software 302 from storage system 304. The processing system 306 can be implemented within a single processing device but can also be distributed across multiple processing devices or sub-systems that cooperate in existing program instructions. Non-limiting examples of processing systems 306 include general purpose central processing units, application specific processors, and logic devices, as well as any other type of processing device, combinations of processing devices, or variations thereof.

The storage system 304 can comprise any storage media readable by processing system 306, and capable of storing software 302. The storage system 304 can include volatile and non-volatile, removable and non-removable media implemented in any method or technology for storage of information, such as, but not limited to, computer readable instructions, data structures, program modules, or other information. The storage system 304 can be implemented as a single storage device but may also be implemented across multiple storage devices or sub-systems. The storage system 304 can further include additional elements, such a controller capable of communicating with the processing system 306.

Non-limiting examples of storage media include random access memory, read only memory, magnetic discs, optical discs, flash memory, virtual memory, and non-virtual memory, magnetic sets, magnetic tape, magnetic disc storage or other magnetic storage devices, or any other medium which can be used to store the desired information and that may be accessed by an instruction execution system, as well as any combination or variation thereof, or any other type of storage medium. In some implementations, the storage media can be a non-transitory storage media. In some implementations, at least a portion of the storage media may be transitory. Storage media may be internal or external to system 300.

As described in further detail herein, computing system 300 receives and transmits data through communication interface 308. The data can include any of the above base data types, updates to form 90, feedback related to form 90, and/or any other data that may pertain to the creation, modification, or use of form 90. In embodiments, the communication interface 308 also operates to send and/or receive information, such as, but not limited to, additional information to/from external systems 140 to which computing system 300 is communicatively connected, input related to initial and updated base data, updates to form 90, feedback related to form 90 and/or any other information that may pertain to the creation or execution of form 90.

The user interface 310 can include one or more of a mouse, a keyboard, a voice input device, a touch input device for receiving a gesture from a user, a motion input device for detecting non-touch gestures and other motions by a user, and/or other comparable input devices and associated processing elements capable of receiving user input from a user. Output devices such as, but not limited to, a video display or graphical display can display textual or graphic portions of form 90, related documents, or another interface further associated with embodiments of the system and method as disclosed herein. Speakers, printers, haptic devices and other types of output devices may also be included in the user interface 310. Employees, supervisory or HR staff, or other staff can communicate with computing system 300 through the user interface 310 in order to view and use form 90, base data, feedback, and documents, enter or receive base data or other information, enter feedback, manage an interaction or back-office task, or any number of other tasks the employee or other staff may want to complete with computing system 300.

In the foregoing description, certain terms have been used for brevity, clearness, and understanding. No unnecessary limitations are to be inferred therefrom beyond the requirement of the prior art because such terms are used for descriptive purposes and are intended to be broadly construed. The different configurations, systems, and method steps described herein may be used alone or in combination with other configurations, systems and method steps. It is to be expected that various equivalents, alternatives and modifications are possible within the scope of the appended claims.

1. A method for automatically creating and generating a form using a development system, comprising:
providing the development system, wherein the development system includes a development analytics engine which is operably connected to and receives input from at least one base data source;
receiving at least one data input from the at least one base data source, wherein the at least one data input includes at least one requirement of a transaction, further wherein the base data is weighted according to predetermined criteria;
analyzing the data input using the development analytics engine; and
creating and generating an optimal form based on the results of the analysis of the data input, wherein the optimal form is a newly generated form.

2. The method of claim 1, further comprising at least one desktop operably connected to the development analytics engine.

3. The method of claim 1, wherein creating and generating the optimal form comprises generating a new form using at least one type of data input from the at least one base data source, and at least one feedback data source, or at least one external system.

4. (canceled)

5. The method of claim 1, further comprising generating at least one compliance metric based on the results of the analysis of the data input.

6. The method of claim 1, further comprising repeating receiving at least one type of data input, analyzing the data input, and producing a form based on the results of the analysis of the data input.

7. The method of claim 1, further comprising storing at least one of the form, a compliance metric, or at least one type of data input in a development analytics memory.

8. The method of claim 1, further comprising storing at least one form in a form database.

9. The method of claim 2, further comprising displaying at least one form on the at least one desktop.

10. The method of claim 1, further comprising transmitting at least one of the form, a compliance metric, or at least one type of data input to at least one external system or at least one desktop.

11. The method of claim 1, wherein analyzing the data input comprises utilizing at least one set of analytics rules within the development analytics engine to analyze the received data

12. The method of claim 11, further comprising updating the at least one set of analytics rules of the development analytics engine.

13. The method of claim 1, further comprising automatically modifying at least one form upon determination of a change to the data input from the at least one base data source, the at least one feedback data source, or the at least one external system.

14. The method of claim 1, further comprising modifying at least one connection between the development analytics engine and the at least one external system.

15. A system for automatically creating and generating a form, comprising:
a processor; and
a non-transitory computer readable medium programmed with computer readable code that upon execution by the processor causes the processor to execute a method for automatically producing a form, comprising:
receiving at least one data input from at least one base data source, wherein the at least on data input includes at least one requirement of a transaction, further wherein the base data is weighted according to predetermined criteria;
analyzing the data input using a development analytics engine; and
creating and generating an optimal form based on the results of the analysis of the data input, wherein the optimal form is a newly generated form.

16. The system of claim 15, wherein the processor receives the data input from the group consisting of at least one base data source, at least one feedback data source, and at least one external system.

17. The system of claim 15, wherein the processor is operatively coupled to a development analytics memory comprising at least one set of analytics rules.

18. The system of claim 15, wherein the processor is operatively coupled to at least one base data source, at least one form database, or at least one desktop.

19. The system of claim 18, wherein the at least one form database comprises a plurality of forms.

20. A non-transitory computer readable medium programmed with computer readable code that upon execution by a processor causes the processor to execute a method for automatically creating and generating a form, comprising:
receiving at least one data input from at least one base data source, wherein the at least one data input include at least one requirement of a transaction, further wherein the base data is weighted according to predetermined criteria;
analyzing the data input using a development analytics engine; and
creating and generating an optimal form based on the results of the analysis of the data input, wherein the optimal form is a newly generated form.
